(19) United States
(12) Patent Application Publication
(10) Pub. No.: US 2010/0320631 A1
(43) Pub. Date: Dec. 23, 2010

(54) METHOD OF PROCESSING SUBSTRATE AND IMPRINT DEVICE

(76) Inventors: Masaru Suzuki, Kanagawa (JP); Takuya Kono, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/720,978

(22) Filed: Mar. 10, 2010

(30) Foreign Application Priority Data
Jun. 23, 2009 (JP) 2009-148199

(51) Int. Cl. B29C 45/76; B29C 59/02

(52) U.S. Cl. 264/40.1; 425/169

(57) ABSTRACT

A method of processing a substrate according to an embodiment includes carrying out an imprint processing that transfer a pattern formed in a template onto a flowable material disposed on a semiconductor substrate so as to obtain a transfer pattern, and at least one processing selected from the group consisting of an inspection processing of an semiconductor substrate, an applying processing of a separating material and an inspection-cleaning processing in parallel in the same processing chamber.

### CROSS-REFERENCE TO RELATED APPLICATIONS

This application is based upon and claims the benefit of priority from prior Japanese Patent Application No. 2009-148199, filed on Jun. 23, 2009 the entire contents of which are incorporated herein by reference.

### BACKGROUND

An imprint lithography method described below is known as a conventional technique. The imprint lithography method is a method that carries out an imprint processing that a film formed on a substrate is divided into a plurality of virtual regions and a pattern is transferred onto the film by impressing a template detachably including a mold in which the pattern is formed on each region of the film, and the method is a method that is capable of inspecting whether the pattern transferred has abnormality or not during the imprint processing is carried out in the other regions. The technique is disclosed in, for example, JP-2007-523492 A.

According to the imprint lithography method, when abnormality is found out in the pattern transferred, parts having abnormality can be identified due to whether the abnormality is reproduced or not after the template, mold and the like concerned with the imprint processing are replaced and the imprint processing is carried out again.

### BRIEF SUMMARY

A method of processing a substrate according to one embodiment includes carrying out in parallel an imprint processing that transfer a pattern formed in a first template onto a flowable material disposed on a semiconductor substrate so as to obtain a transfer pattern, and at least one processing selected from the group consisting of an inspection processing of an semiconductor substrate that inspects the semiconductor substrate used for an imprint processing different from the imprint processing, an applying processing of a separating material that applies a separating material to a surface of a pattern formed in a second template used for the imprint processing different from the imprint processing and an inspection-cleaning processing that inspects a third template used for an imprint processing carried out before the imprint processing and cleans the third template in case that the third template is determined as reusable by the inspection thereof in the same processing chamber.

An imprint device according to another embodiment includes an imprint processing part for carrying out an imprint processing that transfers a pattern formed in a template onto a flowable material disposed on a semiconductor substrate so as to obtain a transfer pattern, a processing chamber housing at least one of an inspection part of a substrate that inspects an semiconductor substrate used for an imprint processing equal to or different from the imprint processing, an applying processing part of a separating material that applies a separating material to a surface of a pattern formed in the template used for the imprint processing equal to or different from the imprint processing, an inspection part that inspects a template used for an imprint processing carried out before the imprint processing, and a cleaning part that cleans the template in case that the template is determined as reusable by the inspection of the inspection part and a control part that controls in parallel at least one of the inspection part of the substrate, the applying processing part of the separating material, the inspection part and the cleaning part, and the imprint processing part.

### BRIEF DESCRIPTION OF THE DRAWING

FIG. 1 is an explanatory view schematically showing an imprint device according to a first embodiment;

FIG. 2 is a plan view schematically showing a wafer used in the first embodiment;

FIGS. 3A to 3C are cross-sectional views schematically showing processes in a pre-imprint inspection part with regard to a method of manufacturing a semiconductor device according to the first embodiment;

FIGS. 4A to 4C are cross-sectional views schematically showing processes in an imprint processing part with regard to a method of manufacturing a semiconductor device according to the first embodiment;

FIG. 5 is a flow chart showing a method of manufacturing a semiconductor device according to the first embodiment;

FIG. 6 is an explanatory view schematically showing an imprint device according to a second embodiment;

FIG. 7 is a flow chart showing a method of manufacturing a semiconductor device in case that an inspection and cleaning of a template used in the second embodiment is completed within a third period;

FIG. 8 is a flow chart showing in case that an inspection and cleaning of a template used in the second embodiment is not completed within a third period;

FIG. 9 is an explanatory view schematically showing an imprint device according to a third embodiment;

FIG. 10 is a flow chart showing according to the third embodiment;

FIG. 11 is an explanatory view schematically showing an imprint device according to a fourth embodiment;

FIG. 12 is a flow chart according to the fourth embodiment showing a case that a wafer inspection after an imprint processing is carried out in first in the third period;

FIG. 13 is a flow chart according to the fourth embodiment showing a case that a wafer inspection before an imprint processing is carried out in first in the third period.

### DETAILED DESCRIPTION

### First Embodiment

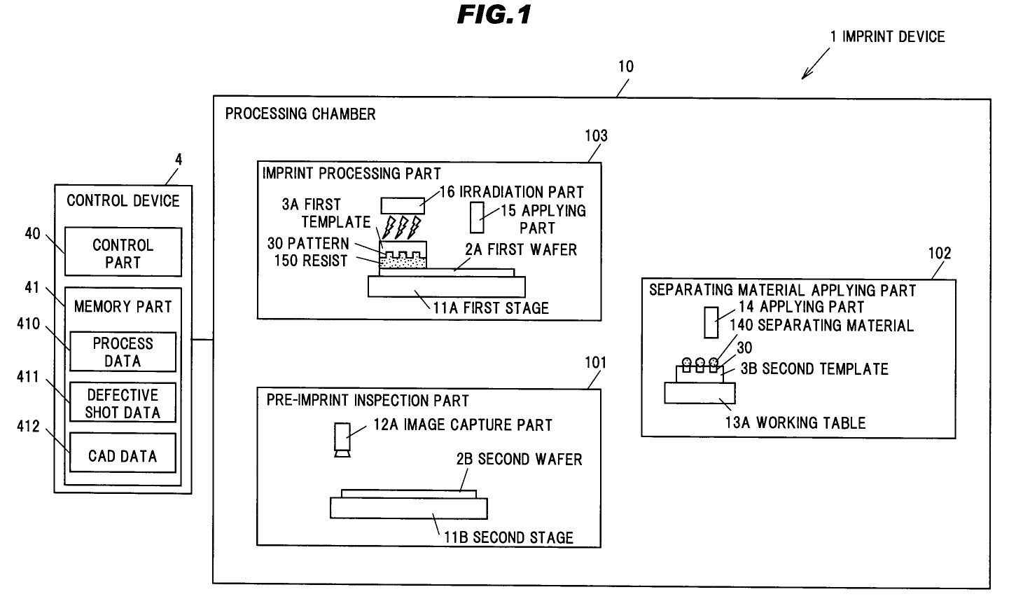

FIG. 1 is an explanatory view schematically showing an imprint device according to a first embodiment. Hereinafter, components having the same composition and function and existing more than one, such as first and second wafers 2A, 2B, first and second templates 3A, 3B, first and second stages 11A, 11B are merely described as wafer, template, stage respectively, when it is not needed to be differentiated. Also, as an example, a pattern of each template is described as a pattern 30 by supposing that the pattern is equal to each other, but not limited to this, the pattern can be different from each other.

As shown in FIG. 1, the imprint device 1 carrying out in parallel a first imprint processing that transfer a pattern 30 formed in a first template 3A and to whose surface a separating material 140 is applied, onto a resist 150 as a flowable material disposed on a first wafer 2A as a first semiconductor substrate, an inspection processing of a second wafer 2B as a second semiconductor substrate that inspects the second wafer 2B used for a second imprint processing that is carried out after the first imprint processing, and an applying processing of the separating material 140 that applies a separating material 140 to a surface of the pattern 30 formed in a second template 3B used for the second imprint processing in the same processing chamber 10.

Here, the first wafer 2A shown in FIG. 1 can be, for example, a wafer at the head of a lot, and a wafer to which the imprint processing is applied following the imprint processing of the first wafer 2A is referred to as a second wafer 2B, a wafer to which the imprint processing is applied following the imprint processing of the second wafer 2B is referred to as a third wafer, and so on. Also, with regard to stages shown in FIG. 1, similarly, a stage on which the first wafer 2A is mounted is referred to as a first stage 11A and a stage on which the second wafer 2B is mounted is referred to as a second stage 11B.

Also, the imprint device 1 includes a pre-imprint inspection part 101 as a substrate inspection part that mainly inspects the wafer used for the imprint processing, a separating material applying part 102 that applies the separating material 140 to the surface of the pattern 30 formed in the template used for the imprint processing, an imprint processing part 103 for carrying out the imprint processing that transfers the pattern 30 formed in a template and to whose surface the separating material 140 is applied onto a resist 150 disposed on the wafer as the semiconductor substrate, a processing chamber 10 housing the pre-imprint inspection part 101, the separating material applying part 102 and the imprint processing part 103, and a control part 40 that controls so that at least two of the imprint processing, the wafer inspection processing and the applying processing part are carried out in parallel.

The pre-imprint inspection part 101 is roughly configured to include, for example, an image capture part 12A for capturing an image of a surface of the wafer.

The image capture part 12A is configured so as to output a captured image data of the surface of the wafer to the control device 4. The control part 40 of the control device 4 carries out, for example, an image processing to the captured image data, and carries out an inspection of the surface condition such as adhesion of foreign substances. Further, the pre-imprint inspection part 101 can be configured so as to include a control part for carrying an image processing and to output the inspection result to the control device 4.

The separating material applying part 102 is roughly configured to include, for example, a working table 13A on which the template is mounted, and an applying part 14 that applies the separating material 140 to the pattern 30 of the template.

The separating material 140 is used so as to allow the hardened resist 150 and the template to be easily separated from each other, and as the separating material 140, for example, fluorine-based self-assembled monolayer monomer (SAM), fluorinated diamond like carbon (F-DLC) and the like can be used. Further, in case that the separation between the hardened resist 150 and the template is easy, it is not indispensable to use the separating material 140.

The imprint processing part 103 is roughly configured to include, for example, templates (for example, the first and the second templates 3A, 3B and the third template (not shown)), an applying part 15 that applies the resist 150 on the wafer and an irradiation part 16 that irradiates energy ray to the resist 150 via the template.

The template is formed of, for example, quartz materials and the like having optical transparency to ultraviolet rays. Also, the pattern 30 is formed in the surface of the template facing the wafer. Further, the number of the templates is not limited to this.

The applying part 15 applies, for example, the resist 150 to every shot described below. Further, the applying method is not limited to this, but resist 150 can be applied to the whole of the wafer.

The irradiation part 16 is configured, for example, so as to irradiate energy ray capable of hardening the resist 150 to the resist 150 via the template (hardening processing). The energy ray is, for example, ultraviolet rays.

The resist 150 is, for example, an ultraviolet-curable resist, and it is formed of an ultraviolet-curable resin hardened by an irradiation of ultraviolet rays. Further, the resist 150 is not limited to the ultraviolet-curable resist, but a thermosetting resist hardened by an application of heat, a resist hardened by an irradiation of ultraviolet rays and an application of heat and the like can be used. When the thermosetting resist is used, for example, a hot plate is disposed under the stage instead of the irradiation part 16 and heat is applied to the thermosetting resist via the stage and the wafer so that the resist is hardened.

The control device 4 is roughly configured to include, for example, a control part 40, a memory part 41 that stores a process data 410, a defective shot data 411 and a Computer-Aided Design (CAD) data 412. The control part 40 controls the pre-imprint inspection part 101, the separating material applying part 102 and the imprint processing part 103.

The process data 410 includes data such as an order and parameter of the processes that are necessary for the wafer inspection processing, the separating material applying processing and the imprint processing that the imprint device 1 carries out.

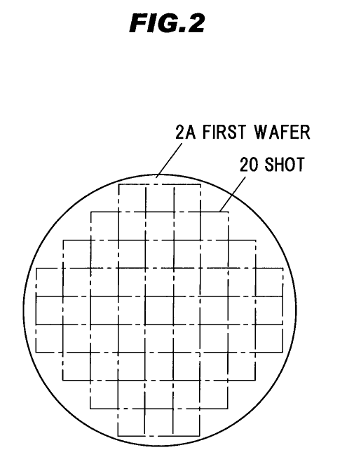

FIG. 2 is a plan view schematically showing a wafer used in the first embodiment. When the first wafer 2A is explained as an example, as shown in FIG. 2, the imprint processing is carried out to the first wafer 2A by applying the resist 150 to each of a plurality of virtual regions as referred to as shot 20. The control part 40 carries out an image processing based on the captured image data outputted by the image capture part 12A of the pre-imprint inspection part 101, determines whether abnormality of adhesion of foreign substances is observed or not in every shot 20. Further, the pre-imprint inspection part 101 can be configured so as to include a control part for carrying an image processing and to output the inspection result to the control part, and stores shots 20 having abnormality as the defective shot data in the memory part 41.

The CAD data 412 includes, for example, data about an arrangement on the wafer of the shots 20 and about a shape of the resist pattern as the transfer pattern to be formed on the wafer. The control part 40 determines whether abnormality is observed or not in shots 20 on the wafer based on the CAD data and the captured image data after the image processing. Further, as a method of determining whether abnormality is observed or not in shots 20 on the wafer that the control part 40 carries out, a method of comparing with the above-mentioned CAD data 412 or a method of using a Die to Die (D/D) system can be adopted. The D/D system means a method that determines abnormality of the shots to be evaluated by comparing the shots to be evaluated with the other shot group and examining whether significant difference exists or not based on the comparison.

Hereinafter, a method of manufacturing a semiconductor device according to the present embodiment will be explained.

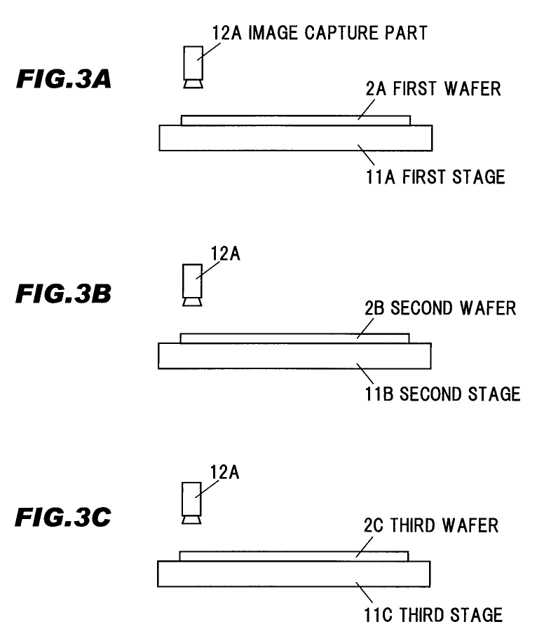

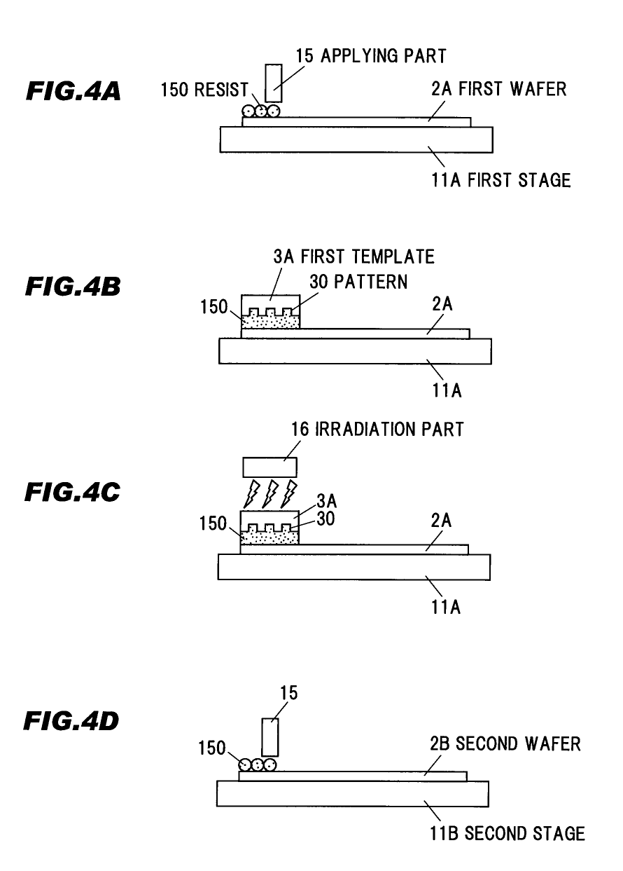

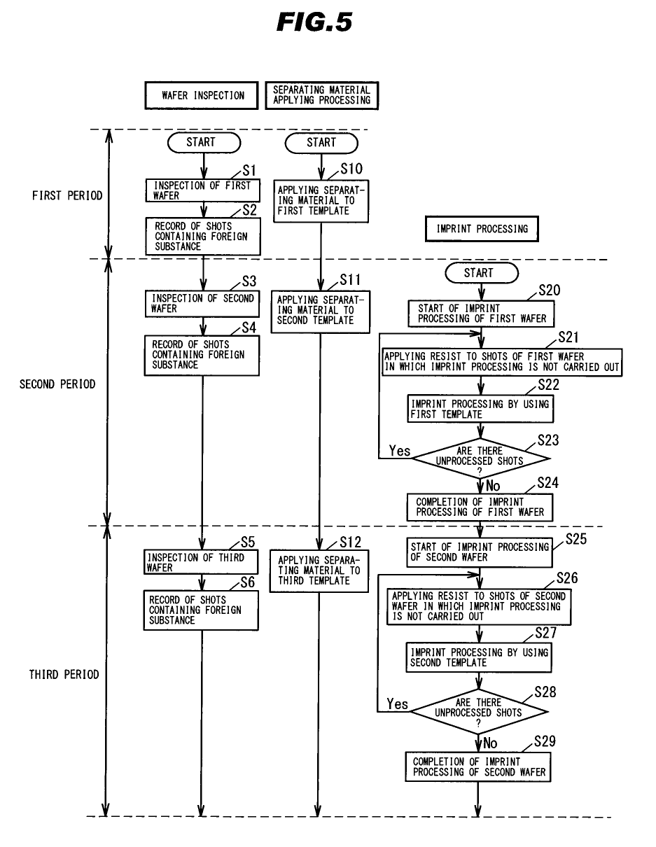

FIGS. 3A to 3C are cross-sectional views schematically showing processes in a pre-imprint inspection part with regard to a method of manufacturing a semiconductor device according to the first embodiment, FIGS. 4A to 4C are cross-sectional views schematically showing processes in an imprint processing part with regard to a method of manufacturing a semiconductor device according to the first embodiment, and FIG. 5 is a flow chart showing a method of manufacturing a semiconductor device according to the first embodiment. A method of manufacturing a semiconductor device including a method of processing a substrate according to the embodiment will be explained as referred to the flow chart shown in FIG. 5. Further, hereinafter, with regard to the processes overlapped with each other, detail explanation will be omitted.

### (Process of First Period)

First, the control part 40 reads out the process data 410 that is necessary for the wafer inspection processing, the separating material applying processing and the imprint processing from the memory part 41. Subsequently, as shown in FIG. 3A, the control part 40 moves the first stage 11A on which the first wafer 2A is mounted to the pre-imprint inspection part and controls the image capture part 12A so that the image capture part 12A outputs the captured image data of the first wafer 2A to the control device 4. Subsequently, the control part 40 carries out an inspection of the first wafer 2A based on the captured image data and the CAD data 412 (S1).

Next, when shots containing foreign substances, namely defective shots exist as a result of the inspection, the control part 40 allows the memory part 41 to record the defective shots as the defective shot data 411 (S2).

In addition, the control part 40 moves the first template 3A on the working table 13A of the separating material applying part 102 during the first period including the Steps 1 and 2, and controls the applying part 14 to apply the separating material 140 to the pattern 30 of the first template 3A as the separating material applying processing (S10).

### (Process of Second Period)

Next, the control part 40 moves the first wafer 2A that has completed the above-mentioned wafer inspection to the imprint processing part 103 along with the first stage 11A, and controls the imprint processing part 103 based on the process data 410, the defective shot data 411 and the CAD data 412 so that the imprint processing of the first wafer 2A is started (S20).

First, as shown in FIG. 4A, the applying part 15 applies the resist 150 to the shots 20 in which the imprint processing is not carried out due to the control of the control part 40 (S21).

Next, the control part 40 carries out the imprint processing by using the first template 3A (S22).

Particularly, as shown in FIG. 4B, the control part 40 moves the first template 3A and first stage 11A relatively so that the resist 150 applied and the pattern 30 of the first template 3A are adhered to each other. Subsequently, as shown in FIG. 4C, the irradiation part 16 irradiates energy ray to the resist 150 via the first template 3A based on the control of the control part 40 so that the resist 150 is hardened and the first template 3A is separated from the resist 150 hardened.

Next, when in the first wafer 2A, there are shots 20 in which the imprint processing is not carried out, namely there are unprocessed shots 20 (S23; Yes), the control part 40 returns to the Step 21 and controls the applying part 15 to apply the resist 150 to the shots 20 in which the imprint processing is not carried out. In addition, when in the first wafer 2A, there are not shots 20 in which the imprint processing is not carried out, namely there are not unprocessed shots 20 (S23; No), the control part 40 completes the imprint processing of the first wafer 2A (S24). Further, with regard to shots 20 determined as the defective shots in the wafer inspection in each embodiment, an application of the resist 150 is carried out, but a transfer of the pattern 30 is not carried out. A hardening processing is carried out to the resist 150 applied to the defective shots.

The control part 40 controls the pre-imprint inspection part 101 to carry out the wafer inspection of the second wafer 2B during the second period including the above-mentioned Steps 20 to 24.

First, as shown in FIG. 3B, the control part 40 moves the second stage 11B on which the second wafer 2B is mounted to the pre-imprint inspection part 101 and controls the image capture part 12A to output the captured image data of the second wafer 2B to the control device 4. Subsequently, the control part 40 carries out an inspection of the second wafer 2B based on the captured image data and the CAD data 412 (S3).

Next, the control part 40 allows the memory part 41 to record the defective shots, namely shots containing foreign substances as the defective shot data 411 (S4).

In addition, the control part 40 moves the second template 3B on the working table 13A of the separating material applying part 102 during the second period and controls the applying part 14 to apply the separating material 140 to the pattern 30 of the second template 3B as the separating material applying processing (S11).

### (Process of Third Period)

Next, the control part 40 moves the second wafer 2B that has completed the above-mentioned wafer inspection to the imprint processing part 103 along with the second stage 11B, and controls the imprint processing part 103 based on the process data 410, the defective shot data 411 and the CAD data 412 so that the imprint processing of the second wafer 2B is started (S25).

First, the applying part 15 applies the resist 150 to the shots 20 in which the imprint processing is not carried out due to the control of the control part 40 (S26).

Next, the control part 40 carries out the imprint processing by using the second template 3B (S27).

Particularly, the control part 40 moves the second template 3B and second stage 11B relatively so that the resist 150 applied and the pattern 30 of the second template 3B are adhered to each other. Subsequently, the irradiation part 16 irradiates energy ray to the resist 150 via the second template 3B based on the control of the control part 40 so that the resist 150 is hardened and the second template 3B is separated from the resist 150 hardened.

Next, when in the second wafer 2B, there are shots 20 in which the imprint processing is not carried out, namely there are unprocessed shots 20 (S28; Yes), the control part 40 returns to Step 26 and controls the applying part 15 to apply the resist 150 to the shots 20 in which the imprint processing is not carried out. In addition, when in the second wafer 2B, there are not shots 20 in which the imprint processing is not carried out, namely there are not unprocessed shots 20 (S28; No), the control part 40 completes the imprint processing of the second wafer 2B (S29).

The control part 40 controls the pre-imprint inspection part 101 to carry out the wafer inspection of the third wafer 2C during the third period including the above-mentioned Steps 25 to 29.

First, as shown in FIG. 3C, the control part 40 moves the third stage 11C on which the third wafer 2C is mounted to the pre-imprint inspection part 101 and controls the image capture part 12A to output the captured image data of the third wafer 2C to the control device 4. Subsequently, the control part 40 carries out an inspection of the third wafer 2C based on the captured image data and the CAD data 412 (S5).

Next, the control part 40 allows the memory part 41 to record the defective shots, namely shots containing foreign substances as the defective shot data 411 (S6).

In addition, the control part 40 moves the third template on the working table 13A of the separating material applying part 102 during the third period and controls the applying part 14 to apply the separating material 140 to the pattern 30 of the third template as the separating material applying processing (S12).

An etching processing is carried out to the resist pattern 151 that is formed in the wafer via the above-mentioned processes so that a part of the wafer is exposed and a mask based on the resist pattern is formed. Subsequently, a selective etching processing is carried out to the mask so that a predetermined pattern is formed on the wafer, and remaining resist pattern is removed. Subsequently, well-known processes are carried out so that a predetermined semiconductor device is obtained.

### (Advantages of the First Embodiment)

According to the present embodiment, the following advantages are obtained.

(1) A wafer inspection processing, a separating material applying processing and an imprint processing can be carried out in parallel so that throughput can be enhanced in comparison with a case that the wafer inspection processing, the separating material applying processing and the imprint processing are not carried out in parallel.
(2) The wafer inspection processing, the separating material applying processing and the imprint processing can be carried out in the processing chamber 10 so that adhesion of foreign substances due to transfer between the processes can be prevented and yield ratio can be enhanced.
(3) The defective shots on the wafer is recorded on the memory part 41 as the defective shot data 411 and an application of the resist 150 is carried out, but a transfer of the pattern 30 is not carried out, so that throughput and life time of the template can be enhanced.
(4) The throughput and yield ratio can be enhanced so that production cost of the semiconductor device can be reduced.

### Second Embodiment

The imprint device 1 of the second embodiment is different from that of the first embodiment in further including a template inspection part 104 and a cleaning part 105. Further, in each of the following embodiments, an explanation about the same part and process as the first embodiment will be omitted or simplified.

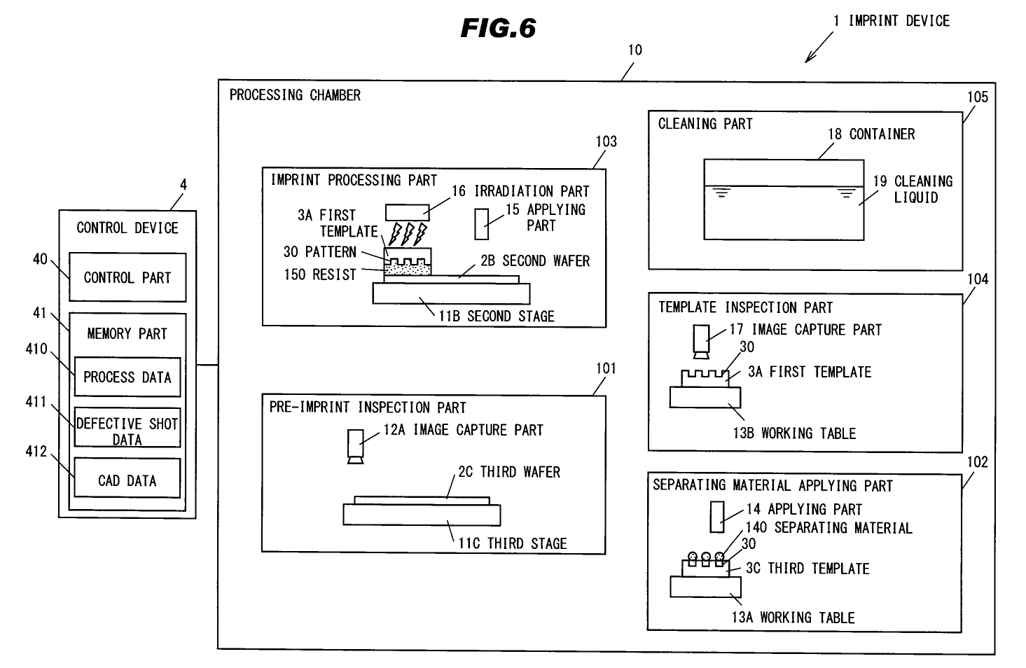

FIG. 6 is an explanatory view schematically showing an imprint device according to a second embodiment. As shown in FIG. 6, the imprint device 1 of the present embodiment is roughly configured to include a pre-imprint inspection part 101, a separating material applying part 102, an imprint processing part 103, a template inspection part 104 that carries out a template inspection and a cleaning part 105 that carries out a template cleaning in the processing chamber 10.

The template inspection part 104 is roughly configured to include a working table 13B, and an image capture part 17. The template inspection part 104 is controlled by the control part 40.

The image capture part 17 is configured, for example, so as to output captured image data obtained by capturing the pattern 30 of the template to the control device 4. The control part 40 carries out, for example, an image processing to the captured image data, and an inspection of the surface condition such as adhesion of foreign substances. Further, the template inspection part 104 can be configured so as to include a control part for carrying an image processing and to output the inspection result to the control device 4.

Here, the CAD data 412 used in the present embodiment includes data of the pattern 30 formed in the template. The control part 40 carries out a template inspection based on the captured image data of the template and the CAD data 412.

The cleaning part 105 is roughly configured to include, for example, a container 18 filled with a cleaning liquid 19. The cleaning part 105 is controlled by the control part 40. Further, for example, incase that the imprint device 1 includes not less than four templates, the imprint device 1 can carries out the cleaning of the templates over a period of time longer than a period of time required for the imprint processing. The templates are cleaned over a long period of time so that the hardened resist, foreign substances and the like that have adhered to the templates at the time of the imprint processing can be removed. A case that the cleaning of the template is not completed within the third period will be explained later.

The cleaning liquid 19 is, for example, an aqueous hydrogen peroxide sulfate solution.

Hereinafter, a method of manufacturing a semiconductor device according to the present embodiment will be explained.

### (Method of Manufacturing Semiconductor Device)

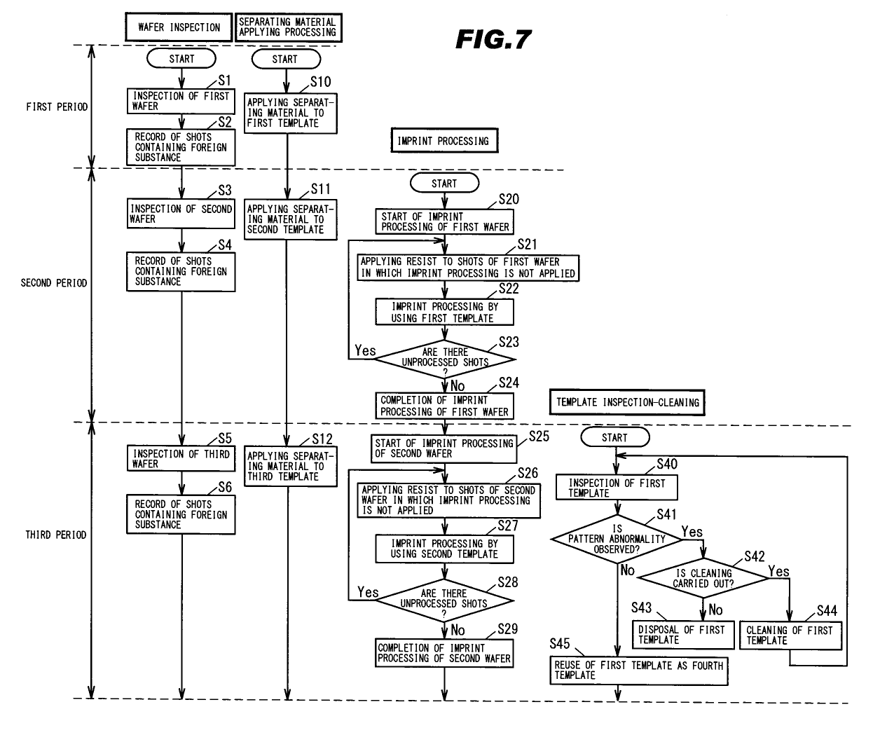

FIG. 7 is a flow chart showing a method of manufacturing a semiconductor device in case that an inspection and cleaning of a template used in the second embodiment is completed within a third period. First, a case that the inspection and cleaning of the template is completed within the third period shown in FIG. 7 will be explained.

The wafer inspection processing, the separating material applying processing and the imprint processing that are shown in FIG. 7 as Steps 1 to 6, Steps 10 to 12 and Steps 20 to 29 are carried out in the same manner as each Step shown in the first embodiment. Hereinafter, the inspection and cleaning of the template that is carried out during the third period will be explained in accordance with the flow chart shown in FIG. 7.

The control part 40 moves the first template 3A that has been used in the second period to the working table 13B of the template inspection part 104 during the third period and controls the image capture part 17 to output the captured image data of the pattern 30 of the first template 3A to the control device 4. The control part 40 carries out an inspection of the pattern 30 of the first template 3A based on the captured image data and the CAD data 412 (S40).

Next, when the pattern 30 of the first template 3A has abnormality, namely pattern abnormality is observed (S41; Yes), the control part 40 determines based on the degree of abnormality whether cleaning of the first template 3A is carried out or not. When the control part 40 determines that the abnormality of the pattern 30 of the first template 3A can not be recovered by the cleaning, namely determines that it can not be reused (S42; No), the control part 40 disposes of the first template 3A (S43). When the control part 40 determines that the abnormality of the pattern 30 of the first template 3A can be recovered by the cleaning, namely determines that it can be reused (S42; Yes), the control part 40 moves the first template 3A to the cleaning part 105 and controls the cleaning part 105 to clean the first template 3A with the cleaning liquid 19 (S44). After the cleaning, the control part 40 moves the first template 3A on the working table 13B of the template inspection part 104 and carries out the inspection of the first template 3A shown in Step 40 again.

Here, in Step 41, when the pattern 30 of the first template 3A does not have abnormality or the pattern 30 of the first template 3A after the cleaning does not have abnormality (S41; No), since the application of the separating material 104 to the third template 3C is completed in Step 12, the first template 3A is reused as a fourth template used for an imprint processing of a fourth wafer (S45).

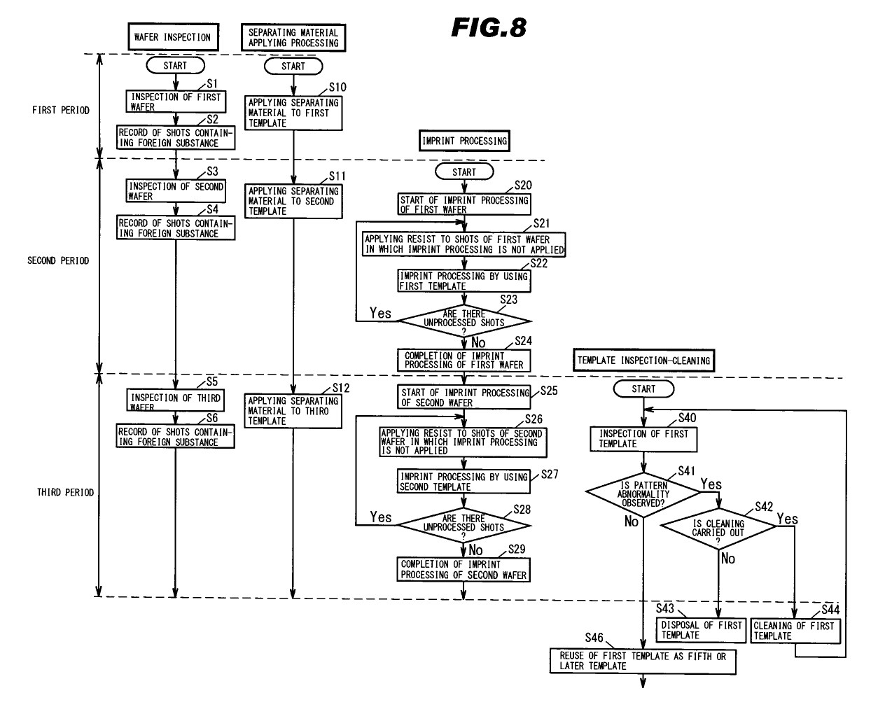

FIG. 8 is a flow chart showing in case that an inspection and cleaning of a template used in the second embodiment is not completed within a third period. Subsequently, a case that the inspection and cleaning of the template is not completed within the third period will be explained in accordance with the flow chart shown in FIG. 8.

The wafer inspection processing, the separating material applying processing and the imprint processing that are shown in FIG. 8 as Steps 1 to 6, Steps 10 to 12, Steps 20 to 29 and Steps 40 to 44 are carried out in the same manner as each Step shown in FIG. 7.

In Step 41, when the pattern 30 of the first template 3A does not have abnormality (S41; No), the control part 40 does not use the first template 3A for the imprint processing of the fourth template, but reuses it as the fifth or later template (S46).

An etching processing is carried out to the resist pattern 151 that is formed in the wafer via the above-mentioned processes so that a part of the wafer is exposed and a mask based on the resist pattern is formed. Subsequently, a selective etching processing is carried out to the mask so that a predetermined pattern is formed on the wafer, and remaining resist pattern is removed. Subsequently, well-known processes are carried out so that a predetermined semiconductor device is obtained.

### (Advantages of the Second Embodiment)

According to the present embodiment, the following advantages are obtained.

(1) The inspection and cleaning of the template is carried out so that protection of the template can be effectively carried out and life time of the template can be checked early.
(2) The template having abnormality can be reused due to the cleaning so that production cost of the semiconductor device can be reduced.

### Third Embodiment

The imprint device 1 of the third embodiment is different from that of the second embodiment in further including a post-imprint inspection part 106.

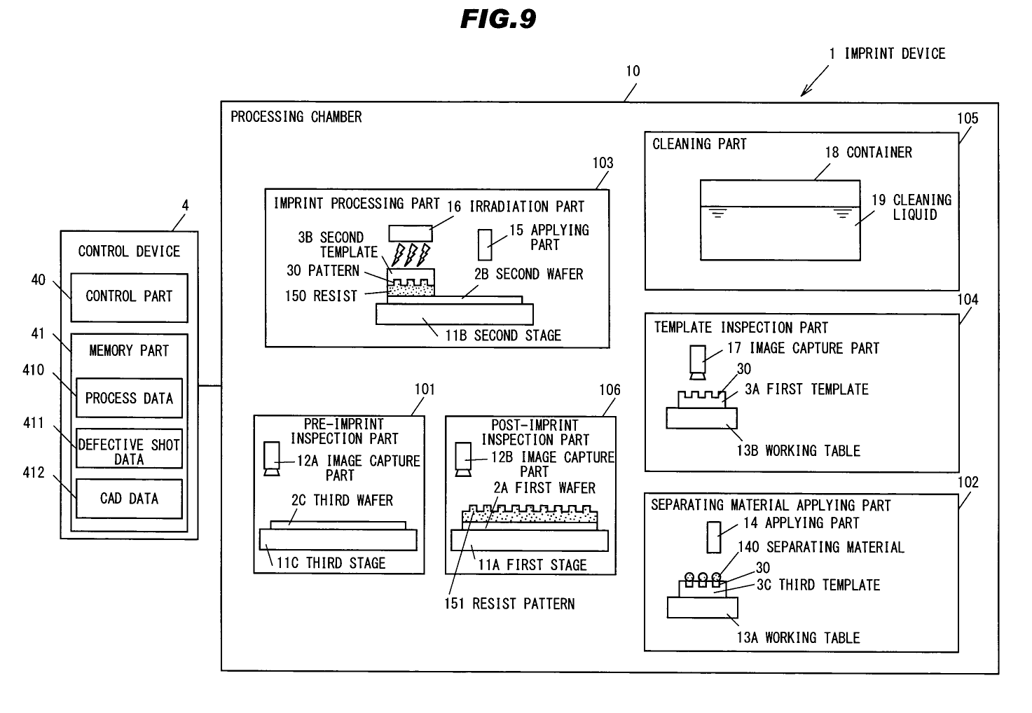

FIG. 9 is an explanatory view schematically showing an imprint device according to a third embodiment. As shown in FIG. 9, the imprint device 1 of the present embodiment is roughly configured to include a pre-imprint inspection part 101, a separating material applying part 102, an imprint processing part 103, a template inspection part 104 that carries out a template inspection, a cleaning part 105 that carries out a template cleaning and a post-imprint inspection part 106 that carries out a wafer inspection after the imprint processing in the processing chamber 10.

The post-imprint inspection part 106 is used for carrying out an inspection of the wafer that has completed the imprint processing. The post-imprint inspection part 106 is roughly configured to include an image capture part 12B that captures a surface of the wafer. The post-imprint inspection part 106 is controlled by the control part 40.

The image capture part 12B is configured, for example, so as to output captured image data obtained by capturing the resist pattern 151 formed in the surface of the wafer to the control device 4. The control part 40 carries out, for example, an image processing to the captured image data, and an inspection of the surface condition such as adhesion of foreign substances. Further, the post-imprint inspection part 106 can be configured so as to include a control part for carrying an image processing and to output the inspection result to the control device 4.

Here, the CAD data 412 used in the present embodiment includes data of the resist pattern 151 formed in the wafer. The control part 40 carries out a wafer inspection after the imprint processing based on the captured image data of the resist pattern 151 and the CAD data 412.

Hereinafter, a method of manufacturing a semiconductor device according to the present embodiment will be explained.

### (Method of Manufacturing Semiconductor Device)

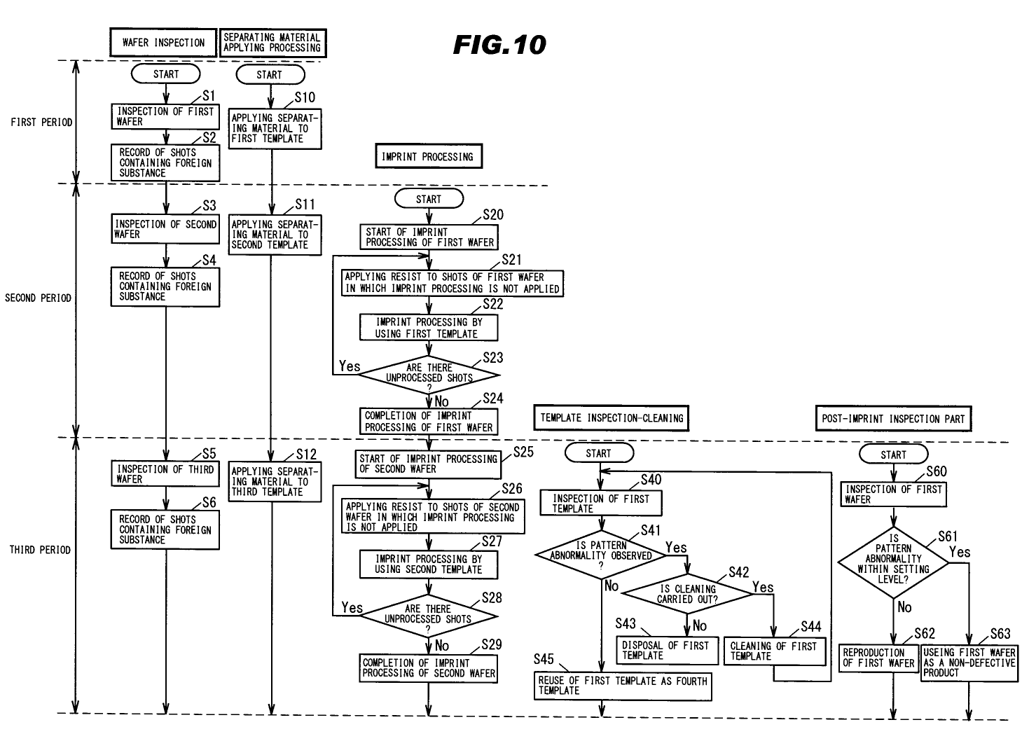

FIG. 10 is a flow chart showing according to the third embodiment.

The wafer inspection processing, the separating material applying processing, the imprint processing and the template inspection and cleaning processing that are shown in FIG. 10 as Steps 1 to 6, Steps 10 to 12, Steps 20 to 29 and Steps 40 to 45 are carried out in the same manner as each Step shown in each embodiment. Hereinafter, the wafer inspection after the imprint processing that is carried out during the third period will be explained in accordance with the flow chart shown in FIG. 10.

The control part 40 moves the first wafer 2A to which the imprint processing has been carried out in the second period to the post-imprint inspection part 106 during the third period and controls the image capture part 12B to output the captured image data of the resist pattern 151 formed in the first wafer 2A to the control device 4. The control part 40 carries out an inspection of the resist pattern 151 of the first wafer 2A based on the captured image data and the CAD data 412 (S60).

Next, when abnormality of the resist pattern 151 is beyond a predetermined setting level (S61; No), the control part 40 carries out reproduction of the first wafer 2A (S62). The reproduction of the wafer is carried out, for example, in case that a content ratio of shots having abnormality to all of the shots 20 is not less than a predetermined ratio (for example, several %). In addition, the reproduction of the wafer is carried out, for example, by separating the resist on the wafer and further cleaning the wafer. The imprint processing is carried out to the reproduced wafer again.

Here, when the resist pattern 151 of the first wafer 2A does not have abnormality, or the abnormality is within a predetermined setting level (S61; Yes), the control part 40 allows the first wafer 2A to use as a non-defective product (S63).

An etching processing is carried out to the resist pattern 151 that is formed in the wafer via the above-mentioned processes so that apart of the wafer is exposed and a mask based on the resist pattern is formed. Subsequently, a selective etching processing is carried out to the mask so that a predetermined pattern is formed on the wafer, and remaining resist pattern is removed. Subsequently, well-known processes are carried out so that a predetermined semiconductor device is obtained.

### (Advantages of the Third Embodiment)

According to the present embodiment, the following advantages are obtained.

(1) By inspecting the resist pattern formed in the wafer, it is determined whether reproduction of the wafer is carried out or use the wafer as a non-defective product is carried out, so that the number of disposal and defective product of the wafer can be reduced and production cost of the semiconductor device can be reduced.
(2) The wafer inspection after the imprint processing is carried out during an imprint processing of a wafer to which the subsequent imprint processing is to be carried out so that abnormality of the template and the like can be found early.
(3) The wafer inspection processing, the separating material applying processing, the imprint processing, the template inspection and cleaning processing and the wafer inspection after the imprint processing can be carried out in the processing chamber 10, so that adhesion of foreign substances due to transfer between the processes can be prevented and yield ratio can be enhanced.

### Fourth Embodiment

The imprint device 1 of the fourth embodiment is different from that of the third embodiment in that the pre-imprint inspection part 101 and the post-imprint inspection part 106 are replaced with an inspection part 107.

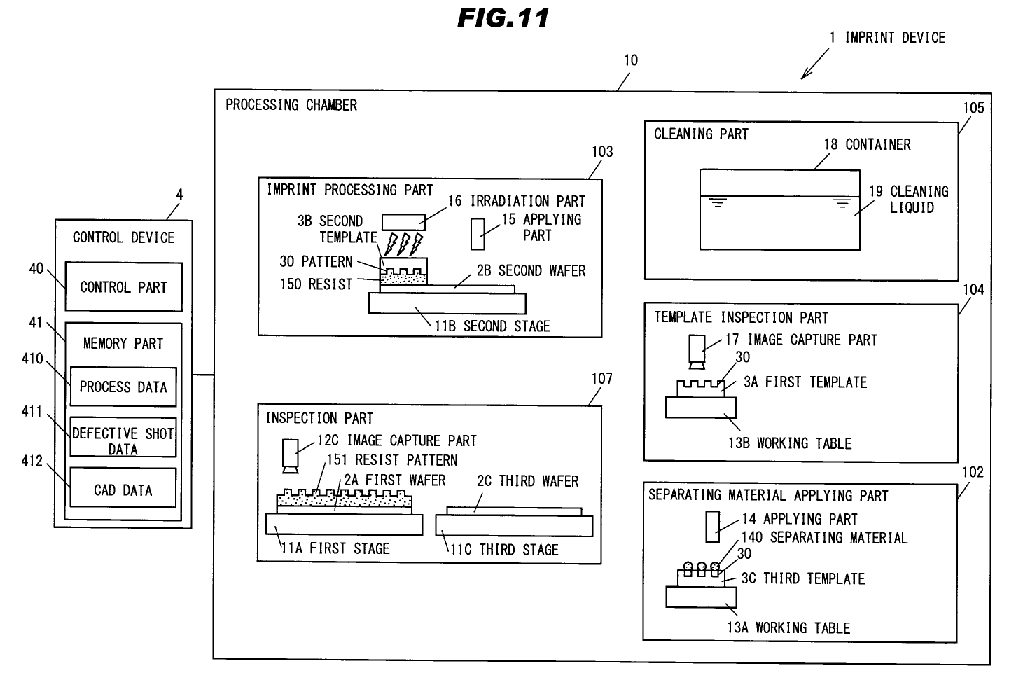

FIG. 11 is an explanatory view schematically showing an imprint device according to a fourth embodiment. As shown in FIG. 11, the imprint device 1 of the present embodiment is roughly configured to include the inspection part 107 instead of the pre-imprint inspection part 101 and the post-imprint inspection part 106.

The inspection part 107 is used for carrying out an inspection of the wafer before the imprint processing and the resist pattern 151 formed in the wafer after the imprint processing. The inspection part 107 is roughly configured to include an image capture part 12C that captures a surface of the wafer. The inspection part 107 is controlled by the control part 40.

Hereinafter, a method of manufacturing a semiconductor device according to the present embodiment will be explained.

### (Method of Manufacturing Semiconductor Device)

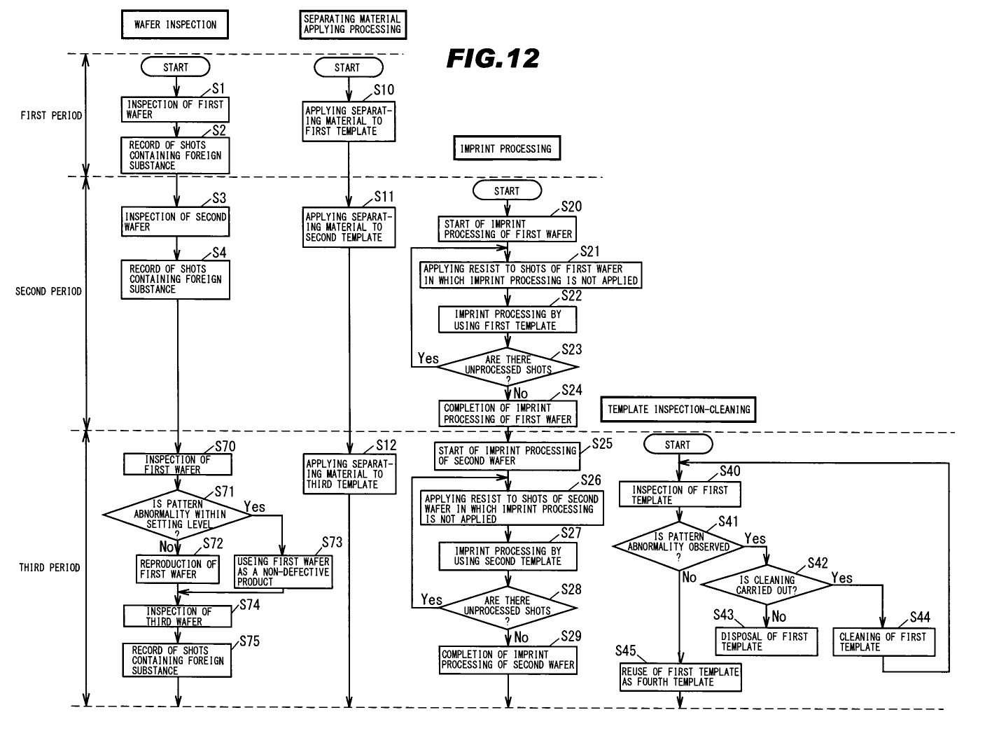

FIG. 12 is a flow chart according to the fourth embodiment showing a case that a wafer inspection after an imprint processing is carried out in first in the third period. The case that the wafer inspection after the imprint processing is carried out earlier than the wafer inspection before the imprint processing in the third period will be explained in accordance with the flow chart shown in FIG. 12.

The wafer inspection processing, the separating material applying processing, the imprint processing and the template inspection and cleaning processing that are shown in FIG. 12 as Steps 1 to 4, Steps 10 to 12, Steps 20 to 29 and Steps 40 to 45 are carried out in the same manner as each Step shown in each embodiment.

The control part 40 moves the first wafer 2A to which the imprint processing has been carried out in the second period to the inspection part 107 during the third period and controls the image capture part 12C to output the captured image data of the resist pattern 151 formed in the first wafer 2A to the control device 4. The control part 40 carries out an inspection of the resist pattern 151 of the first wafer 2A based on the captured image data and the CAD data 412 (S70).

Next, when abnormality of the resist pattern 151 is beyond a predetermined setting level (S71; No), the control part 40 carries out reproduction of the first wafer 2A (S72).

Here, when the resist pattern 151 of the first wafer 2A does not have abnormality, or the abnormality is within a predetermined setting level (S71; Yes), the control part 40 allows the first wafer 2A to use as a non-defective product (S73).

Next, the control part 40 moves the third wafer 2C to the inspection part 107 along with the third stage 11C during the third period and controls the image capture part 12C to output the captured image data of the third wafer 2C to the control device 4. The control part 40 carries out an inspection of the third wafer 2C based on the captured image data and the CAD data 412 (S74).

Next, the control part 40 allows the memory part 41 to record shots containing foreign substances observed due to the inspection, namely defective shots, as the defective shot data 411 (S75).

Hereinafter, the case that the wafer inspection before the imprint processing is carried out earlier than the wafer inspection after the imprint processing in the third period will be explained.

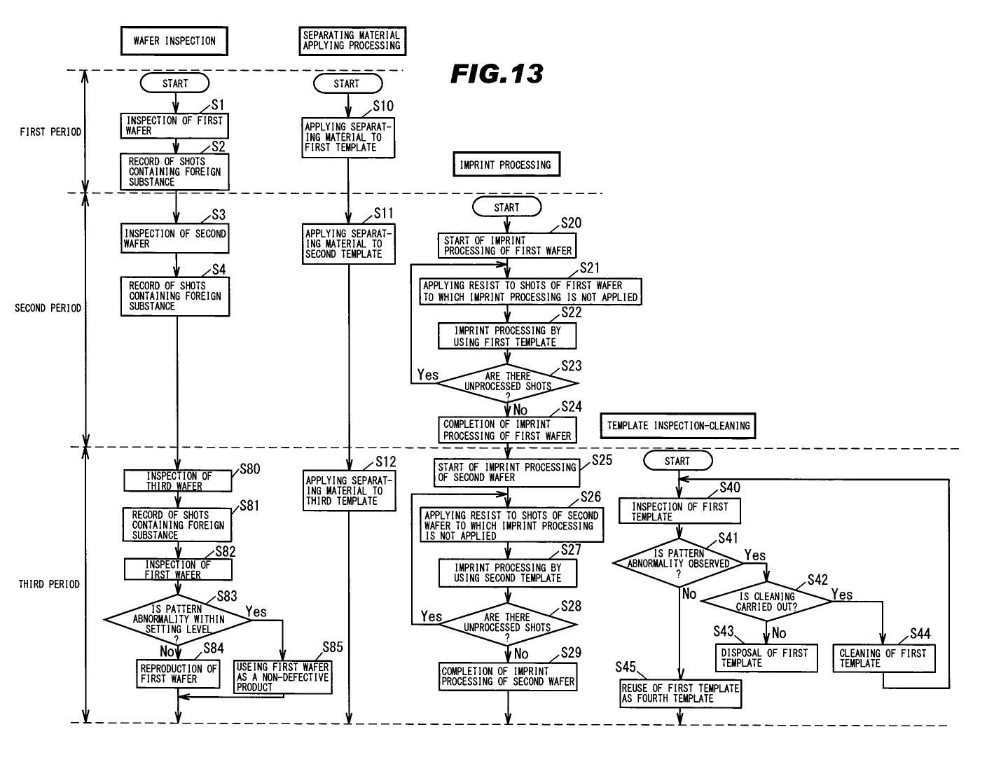

FIG. 13 is a flow chart according to the fourth embodiment showing a case that a wafer inspection before an imprint processing is carried out in first in the third period.

The wafer inspection processing, the separating material applying processing, the imprint processing and the template inspection and cleaning processing that are shown in FIG. 13 as Steps 1 to 4, Steps 10 to 12, Steps 20 to 29 and Steps 40 to 45 are carried out in the same manner as each Step shown in each embodiment.

The control part 40 moves the third stage 11C on which the third wafer 2C is mounted to the inspection part 107 during the third period and controls the image capture part 12C to output the captured image data of the third wafer 2C to the control device 4. Subsequently, the control part 40 carries out an inspection of the third wafer 2C based on the captured image data and the CAD data 412 (S80).

Next, when there are defective shots observed due to the inspection, the control part 40 allows the memory part 41 to record the defective shots as the defective shot data 411 (S81).

Next, the control part 40 moves the first wafer 2A to which the imprint processing has been carried out in the second period to the inspection part 107 during the third period and controls the image capture part 12C to output the captured image data of the resist pattern 151 formed in the first wafer 2A to the control device 4. The control part 40 carries out an inspection of the resist pattern 151 of the first wafer 2A based on the captured image data and the CAD data 412 (S82).

Next, when abnormality of the resist pattern 151 is beyond a predetermined setting level (S83; No), the control part 40 carries out reproduction of the first wafer 2A (S84).

Here, when the resist pattern 151 of the first wafer 2A does not have abnormality, or the abnormality is within a predetermined setting level (S83; Yes), the control part 40 allows the first wafer 2A to use as a non-defective product (S85).

An etching processing is carried out to the resist pattern 151 that is formed in the wafer via the above-mentioned processes so that a part of the wafer is exposed and a mask based on the resist pattern is formed. Subsequently, a selective etching processing is carried out to the mask so that a predetermined pattern is formed on the wafer, and remaining resist pattern is removed. Subsequently, well-known processes are carried out so that a predetermined semiconductor device is obtained.

### (Advantages of the Fourth Embodiment)

According to the present embodiment, the following advantages are obtained.

The wafers before and after the imprint processing can be inspected by the inspection part 107 so that the number of components can be reduced in comparison with the third embodiment.

### Fifth Embodiment

The imprint device 1 of the fifth embodiment houses, for example, the imprint processing part 103 and the pre-imprint inspection part 101 in the same processing chamber 10.

### (Method of Manufacturing Semiconductor Device)

A method of manufacturing a semiconductor device including a method of processing a substrate that carries out the imprint processing and the inspection processing in parallel is carried out, and well-known processes are carried out, so that a predetermined semiconductor device is obtained.

### Sixth Embodiment

The imprint device 1 of the sixth embodiment houses, for example, the imprint processing part 103 and the separating material applying part 102 in the same processing chamber 10.

### (Method of Manufacturing Semiconductor Device)

A method of manufacturing a semiconductor device including a method of processing a substrate that carries out the imprint processing and the application processing of the separating material 140 in parallel is carried out, and well-known processes are carried out, so that a predetermined semiconductor device is obtained.

### Seventh Embodiment

The imprint device 1 of the seventh embodiment houses, for example, the imprint processing part 103, and the template inspection part 104 and the cleaning part 105 in the same processing chamber 10.

### (Method of Manufacturing Semiconductor Device)

A method of manufacturing a semiconductor device including a method of processing a substrate that carries out the imprint processing and the inspection and cleaning processing of the template in parallel is carried out, and well-known processes are carried out, so that a predetermined semiconductor device is obtained.

### Eighth Embodiment

The imprint device 1 of the eighth embodiment houses, for example, the imprint processing part 103, the pre-imprint inspection part 101, and the template inspection part 104 and the cleaning part 105 in the same processing chamber 10.

### (Method of Manufacturing Semiconductor Device)

A method of manufacturing a semiconductor device including a method of processing a substrate that carries out the imprint processing, the wafer inspection processing and the inspection and cleaning processing of the template in parallel is carried out, and well-known processes are carried out, so that a predetermined semiconductor device is obtained.

### Ninth embodiment

The imprint device 1 of the ninth embodiment houses, for example, the imprint processing part 103, the separating material applying part 102, and the template inspection part 104 and the cleaning part 105 in the same processing chamber 10.

### (Method of Manufacturing Semiconductor Device)

A method of manufacturing a semiconductor device including a method of processing a substrate that carries out the imprint processing, the application processing of the separating material 140, and the inspection and cleaning processing of the template in parallel is carried out, and well-known processes are carried out, so that a predetermined semiconductor device is obtained.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

The imprint device 1 can be configured to further house the post-imprint inspection part 106 in the same processing chamber 10 in addition to the above-mentioned configuration of the first, second, and fifth to ninth embodiments, and it can carryout the inspection of the resist pattern 151 as a transfer pattern transferred onto the resist 150 formed on the wafer by the imprint processing in parallel with the processings that are carried out due to the above-mentioned configuration of the first, second, and fifth to ninth embodiments, and in case that the pre-imprint inspection part 101 and the post-imprint inspection part 106 are included as the component, they can be replaced with the inspection part 107.

The imprint processing in each embodiment described above is carried out by applying the resist to the wafer for every shot, but not limited to this, for example, the imprint processing can be carried out by applying the resist to the template.

The wafer inspection in each embodiment described above is carried out by inspecting the wafer one by one during one period, but not limited to this, for example, the wafer inspection can be carried out continuously.

The separating material applying processing in each embodiment described above is carried out by applying the separating material one by one during one period, but not limited to this, for example, the separating material applying processing can be carried out continuously, in case that there is a large number of the templates.

The wafer inspection processing and/or the inspection processing and cleaning processing of the template can be carried out for every shot.

What is claimed is:

1. A method of processing a substrate, comprising:
carrying out in parallel an imprint processing that transfer a pattern formed in a first template onto a flowable material disposed on a semiconductor substrate so as to obtain a transfer pattern, and at least one processing selected from the group consisting of an inspection processing of an semiconductor substrate that inspects the semiconductor substrate used for an imprint processing different from the imprint processing, an applying processing of a separating material that applies a separating material to a surface of a pattern formed in a second template used for the imprint processing different from the imprint processing and an inspection-cleaning processing that inspects a third template used for an imprint processing carried out before the imprint processing and cleans the third template in case that the third template is determined as reusable by the inspection thereof in the same processing chamber.

2. The method of processing a substrate according to claim 1, wherein an inspection processing of the transfer pattern that inspects the transfer pattern transferred onto the flowable material disposed on the semiconductor substrate is further carried out in parallel in the same processing chamber in addition to the imprint processing and the at least one processing.

3. The method of processing a substrate according to claim 2, wherein the inspection processing of the transfer pattern is carried out by a method that compares with die to die system or Computer Aided Design (CAD) data.

4. The method of processing a substrate according to claim 1, wherein the at least one processing is the inspection processing of the semiconductor substrate and the applying processing of the separating material.

5. The method of processing a substrate according to claim 4, wherein the inspection processing of the transfer pattern that inspects the transfer pattern transferred onto the flowable material disposed on the semiconductor substrate, the imprint processing, the inspection processing of the semiconductor substrate and the applying processing of the separating material are carried out in parallel in the same processing chamber.

6. The method of processing a substrate according to claim 5, wherein the inspection processing of the semiconductor substrate and/or the inspection processing of the transfer pattern is carried out by a method that compares with die to die system or Computer Aided Design (CAD) data.

7. The method of processing a substrate according to claim 6, wherein the imprint processing is not carried out to shots of the semiconductor substrate in which foreign substances are detected by the inspection processing of the semiconductor substrate.

8. The method of processing a substrate according to claim 1, wherein the at least one processing is the applying processing of the separating material and the inspection-cleaning processing.

9. The method of processing a substrate according to claim 8, wherein the inspection processing of the transfer pattern that inspects the transfer pattern transferred onto the flowable material disposed on the semiconductor substrate, the imprint processing, the applying processing of the separating material and the inspection-cleaning processing are carried out in parallel in the same processing chamber.

10. The method of processing a substrate according to claim 9, wherein the inspection processing of the transfer pattern is carried out by a method that compares with die to die system or Computer Aided Design (CAD) data.

11. The method of processing a substrate according to claim 1, wherein the at least one processing is the inspection processing of the semiconductor substrate and the inspection-cleaning processing.

12. The method of processing a substrate according to claim 11, wherein the inspection processing of the transfer pattern that inspects the transfer pattern transferred onto the flowable material disposed on the semiconductor substrate, the imprint processing, the inspection processing of the semiconductor substrate and the inspection-cleaning processing are carried out in parallel in the same processing chamber.

13. The method of processing a substrate according to claim 12, wherein the inspection processing of the semiconductor substrate and/or the inspection processing of the transfer pattern is carried out by a method that compares with die to die system or Computer Aided Design (CAD) data.

14. The method of processing a substrate according to claim 13, wherein the imprint processing is not carried out to shots of the semiconductor substrate in which foreign substances are detected by the inspection processing of the semiconductor substrate.

15. The method of processing a substrate according to claim 1, wherein the at least one processing is the inspection processing of the semiconductor substrate, the applying processing of the separating material and the inspection-cleaning processing.

16. The method of processing a substrate according to claim 15, wherein the inspection processing of the transfer pattern that inspects the transfer pattern transferred onto the flowable material disposed on the semiconductor substrate, the imprint processing, the inspection processing of the semiconductor substrate, the applying processing of the separating material and the inspection-cleaning processing are carried out in parallel in the same processing chamber.

17. The method of processing a substrate according to claim 16, wherein the inspection processing of the semiconductor substrate and/or the inspection processing of the transfer pattern is carried out by a method that compares with die to die system or Computer Aided Design (CAD) data.

18. The method of processing a substrate according to claim 17, wherein the imprint processing is not carried out to shots of the semiconductor substrate in which foreign substances are detected by the inspection processing of the semiconductor substrate.

19. A method of manufacturing a semiconductor device comprising the method of processing a substrate according to any one of claims 1 to 18.

20. An imprint device comprising:
an imprint processing part for carrying out an imprint processing that transfers a pattern formed in a template onto a flowable material disposed on a semiconductor substrate so as to obtain a transfer pattern;
a processing chamber housing at least one of an inspection part of a substrate that inspects an semiconductor substrate used for an imprint processing equal to or different from the imprint processing, an applying processing part of a separating material that applies a separating material to a surface of a pattern formed in the template used for the imprint processing equal to or different from the imprint processing, an inspection part that inspects a template used for an imprint processing carried out before the imprint processing, and a cleaning part that cleans the template incase that the template is determined as reusable by the inspection of the inspection part; and
a control part that controls in parallel at least one of the inspection part of the substrate, the applying processing part of the separating material, the inspection part and the cleaning part, and the imprint processing part.
